(19) United States
(12) Patent Application Publication
(10) Pub. No.: US 2024/0372941 A1
(43) Pub. Date: Nov. 7, 2024

(54) METHOD FOR INDICATING DISCONTINUOUS SATELLITE COVERAGE AND USER EQUIPMENT USING THE SAME

(71) Applicant: Media Tek Singapore Pte. Ltd., Singapore (SG)

(72) Inventors: Puneet, Bengaluru KA (IN); Marko Niemi, Oulu (FI)

(21) Appl. No.: 18/641,647

(22) Filed: Apr. 22, 2024

(30) Foreign Application Priority Data
May 3, 2023 (IN) 202321031566
May 15, 2023 (IN) 202321034173

(51) Int. Cl. H04M 1/72457; H04W 64/00; H04W 84/06; H04W 88/06

(52) U.S. Cl. CPC H04M 1/72457; H04W 64/006; H04W 84/06; H04W 88/06

(57) ABSTRACT

A method for indicating discontinuous satellite coverage and a user equipment (UE) using the same are provided. The user equipment (UE) includes a terminal equipment (TE) and a mobile termination (MT). The terminal equipment (TE) is for providing services to a user of the user equipment (UE). The mobile termination (MT) is further configured to send to the terminal equipment (TE) an information for indicating a discontinuous satellite coverage.

This application claims the benefit of India Provisional application No. 202321031566, filed May 3, 2023, and India Provisional application No. 202321034173, filed May 15, 2023, the disclosure of which is incorporated by reference herein in its entirety.

### TECHNICAL FIELD

The disclosure relates in general to a method and an electric device using the same, and more particularly to a method for indicating discontinuous satellite coverage and a user equipment (UE) using the same.

### BACKGROUND

Deployment option for satellite E-UTRAN access, in which shorter periods of satellite E-UTRAN access radio coverage are followed by longer periods of satellite E-UTRAN access coverage gaps. During coverage gaps, the access stratum may be deactivated. These coverage gaps are called discontinuous coverage.

Currently, there is no method defined in the user equipment (UE) to report discontinuous coverage status or related information to the application layer or the terminal. If the application layer or the terminal is not aware of the discontinuous coverage, then the application layer or the terminal will not be able to take a decision for various procedure trigger e.g., whether to send or to buffer the MO data etc. E.g., the application layer may want to buffer the MO data during a coverage gap i.e., when AS is deactivated due to the discontinuous coverage.

### SUMMARY

The disclosure is directed to a method for indicating discontinuous satellite coverage and a user equipment (UE) using the same. A new interface (message, indicator, method) from 3GPP modem to the terminal equipment (TE), e.g., the attention (AT) command, could be introduced to report discontinuous satellite coverage to the application layer or the terminal equipment (TE) e.g., to report when the user equipment (UE) is deactivated due to the discontinuous satellite coverage or activated when user equipment (UE) comes out from a discontinuous satellite coverage or the user equipment (UE) is in a satellite coverage.

According to one embodiment, a user equipment (UE) is provided. The user equipment (UE) includes a terminal equipment (TE) and a mobile termination (MT). The terminal equipment (TE) is for providing services to a user of the user equipment (UE). The mobile termination (MT) is further configured to send to the terminal equipment (TE) an information for indicating a discontinuous satellite coverage.

According to another embodiment, a method for operating a user equipment (UE) is provided. The user equipment (UE) includes a terminal equipment (TE), for providing services to a user of the user equipment (UE) and a mobile termination (MT). The method includes the following steps: sending to the terminal equipment (TE) an information for indicating a discontinuous satellite coverage.

### BRIEF DESCRIPTION OF THE DRAWINGS

FIG. 1 shows that the attention (AT) command assumes an abstract architecture comprising a TE (e.g. a computer) and a mobile termination (MT) interfaced by a terminal adaptor (TA).

FIG. 2 shows the proposed new attention (AT) command.

FIG. 3 shows an apparatus implementing the technology described in the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

During Registration procedure, a user equipment (UE) supporting the Unavailability Period feature provides “Unavailability Period Support” indication as part of 5GMM Core Network Capability in Registration Request message for initial registration and for every mobility registration. The AMF indicates whether the corresponding feature is supported in the AMF by providing the “Unavailability Period Support” indication in Registration Accept message.

If the user equipment (UE) and the network support Unavailability Period and an event is triggered in the user equipment (UE) that would make the user equipment (UE) unavailable or lose coverage for a certain period of time, the user equipment (UE) uses Support of Unavailability Period to inform the AMF of the expected unavailability and whether it is due to NR satellite access discontinuous coverage. Use of Support of Unavailability Period for loss of coverage due to NR satellite access discontinuous coverage shall only be used if both the user equipment (UE) and the AMF signalled “Unavailability Period Support”.

For NR satellite access that provides discontinuous network coverage the Mobility Management and Power Saving Optimization functionality may be used.

If both the user equipment (UE) and the network support “Unavailability Period Support”, and if the user equipment (UE) determines it will lose coverage and will become unavailable, and the user equipment (UE) decides to remain in no service during that time, then: the user equipment (UE) triggers the Mobility Registration Update procedure to inform the network of its unavailability.

The user equipment (UE) may be able to determine, including considering current and expected future locations of the user equipment (UE), a Start of Unavailability Period and/or Unavailability Period Duration for when it expects to be out of coverage and include them in the Mobility Registration Update procedure.

The user equipment (UE) should trigger the Mobility Registration Update procedure early enough such that the procedure, under normal conditions, is able to complete before the start of the unreachability period.

There are two types of unavailability. One is triggered by user equipment (UE); another is due to satellite discontinuous coverage.

Deployment option for satellite E-UTRAN access, in which shorter periods of satellite E-UTRAN access radio coverage are followed by longer periods of satellite E-UTRAN access coverage gaps. During coverage gaps, the access stratum may be deactivated. These coverage gaps are called discontinuous coverage.

Currently, there is no method defined in user equipment (UE) to report the discontinuous coverage status or related information to application layer or terminal. If the application layer or the terminal is not aware of the discontinuous coverage, then the application layer or the terminal will not be able to take a decision for various procedure trigger e.g., whether to send or to buffer MO data etc. E.g., the application layer may want to buffer MO data during a coverage gap i.e., when AS is deactivated due to the discontinuous coverage.

To solve the stated problem, a new interface (message, indicator, method) from 3GPP modem to the terminal equipment (TE), e.g., the attention (AT) command, could be introduced to report discontinuous satellite coverage to the application layer or the terminal equipment (TE) e.g., to report when the user equipment (UE) is deactivated due to the discontinuous satellite coverage or activated when user equipment (UE) comes out from a discontinuous satellite coverage or user equipment (UE) is in satellite coverage.

The attention (AT) commands are used for controlling the mobile termination (MT) functions and GSM/UMTS/LTE/NR network services from a terminal equipment (TE) such as a computer (equal to DTE: Data Terminal Equipment) through a terminal adaptor (TA) such as a data card (equal to DCE: Data Circuit terminating Equipment). Some attention (AT) commands are defined such way that they can be easily applied to the mobile termination (MT) of networks other than GSM/UMTS/LTE/NR.

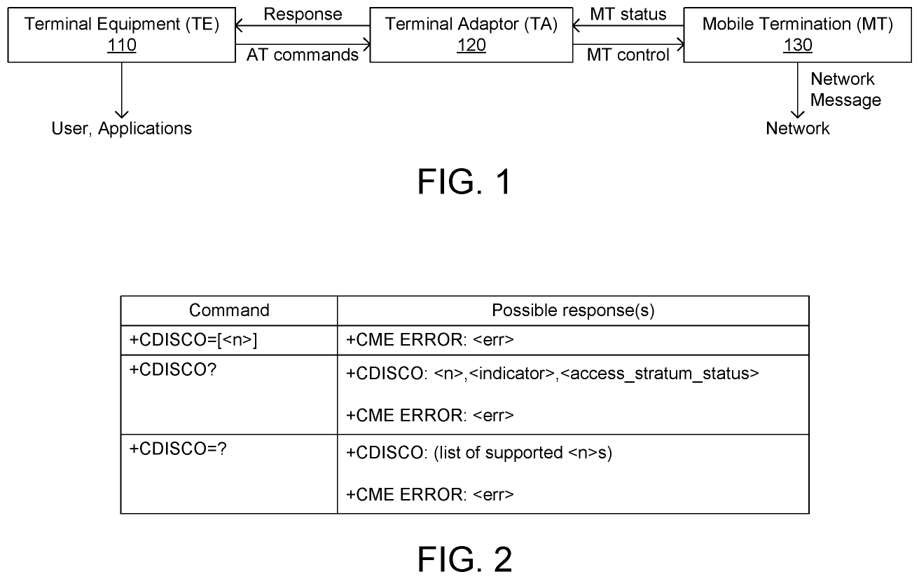

Please refer to FIG. 1, which shows that the attention (AT) command assumes an abstract architecture comprising a TE (e.g. a computer) and a mobile termination (MT) interfaced by a terminal adaptor (TA). The terminal equipment (TE) 110, which performs various actions for the user and applications, may send the attention (AT) commands to the terminal adaptor (TA) 120 that can send responses thereto back to the terminal equipment (TE) 110. The terminal adaptor (TA) 120 may send the mobile termination (MT) control messages to the mobile termination (MT) 130, which can return the mobile termination (MT) status messages back to the terminal adaptor (TA) 120. The mobile termination (MT) 130 also sends the network messages to the one or more networks.

This abstract architecture can be physically implemented in various ways: (1) the terminal adaptor (TA), the mobile termination (MT) and the terminal equipment (TE) as three separate entities; (2) the terminal adaptor (TA) integrated under the mobile termination (MT) cover, and the terminal equipment (TE) implemented as a separate entity; (3) the terminal adaptor (TA) integrated under the terminal equipment (TE) cover, and the mobile termination (MT) implemented as a separate entity; and (4) the terminal adaptor (TA) and the mobile termination (MT) integrated under the terminal equipment (TE) cover as a single entity.

The attention (AT) commands (e.g. GSM/UMTS commands) use certain syntax rules. Standardized basic commands are found only in ITU T Recommendation V.250. GSM/UMTS commands use syntax rules of extended commands. Every extended command has a test command to test the existence of the command and to give information about the type of its sub-parameters. Parameter type commands also have a read command to check the current values of sub-parameters. Action type commands do not store the values of any of their possible sub-parameters, and therefore do not have a read command.

The attention (AT) commands include, for example: General commands, Call control commands, Network service related commands, Mobile Termination (MT) control and status commands, Mobile termination errors result codes, Commands for Packet Domain, Commands for VGCS (Voice Group Call Service) and VBS (Voice Broadcast Service), and Commands for the USIM Application Toolkit.

The Commands for Packet Domain defines commands that the terminal equipment (TE) can use to control a mobile termination (MT) supporting packet switched services.

Packet Domain mobile termination (MT) will vary widely in functionality. At one extreme, a mobile termination (MT) supporting CS/PS or class-A mode of operation might support multiple PDP types as well as circuit switched data, and use multiple external networks and QoS (Quality of Service) profiles. At the other extreme, a mobile termination (MT) supporting only PS or class-C mode of operation might support only a single PDP type using a single external network, and rely on the HLR to contain the PDP context definition.

A comprehensive set of Packet Domain-specific commands provide the flexibility needed by the more complex mobile termination (MT). The commands are designed to be expandable to accommodate new PDP types and interface protocols, merely by defining new values for many of the parameters. Multiple contexts can be activated if the interface link-layer protocol is able to support them. The commands use the extended information and error message capabilities. For the mobile termination (MT) of intermediate complexity, most commands have simplified forms where certain parameters can be omitted. For the simplest mobile termination (MT), and for backwards compatibility with existing communications software, it is possible to control access to the Packet Domain using existing modem-compatible commands. A special dial-string syntax is defined for use with the D command.

Within the Commands for Packet Domain, there are Commands specific to mobile termination (MT) supporting the Packet Domain, and Modem compatibility commands.

Please refer to FIG. 2, which shows the proposed new attention (AT) command. In the FIG. 2, a table: +CDISCO parameter command syntax is shown. An explanation of the description, the defined values, and the defined events, with respect to the +CDISCO parameter command syntax, will be provided hereafter.

### DESCRIPTION

The set command controls the presentation of unsolicited result code +CDISCO: <indicator> when <n>=1 indicator is indicating the discontinuous coverage.

Refer 3GPP 27.007 clause 9.2 for possible <err> values.

Read command returns the current settings of <n> and the indicator for discontinuous coverage.

Test command returns supported <n>s values as a compound value.

### Defined Values

<n>: integer type.

0 Disable presentation of the unsolicited result code +CDISCO: <indicator>.

1 Enable presentation of the unsolicited result code +CDISCO: <indicator>.

<indicator>: integer type. Indicates the current discontinuous coverage status for the terminal equipment (TE) or the user equipment (UE) in the network.

0 indicates that the user equipment (UE) is in satellite coverage.

1 indicates that the user equipment (UE) is out of satellite coverage (i.e., in discontinuous coverage).

<access_stratum_status>: integer type. Indicates the active status of access stratum in the UE due to discontinuous coverage.

0 indicates that access-stratum is not deactivated due to discontinuous coverage.

1 indicates that access-stratum is deactivated due to discontinuous coverage.

### Implementation

This command is only applicable to the user equipment (UE) supporting satellite E-UTRAN access or satellite NR access.

An interface (or method) to provide upper layers (e.g., application/TE) with an information related to satellite(s) in/out of coverage data, ephemeris data, which is either broadcast by a network (satellite) cell or other way provided to the user equipment (UE) over access stratum (AS) or non-access stratum (NAS) protocol signaling.

The interface being a user equipment (UE) implementation specific AT-command(s) or other UE-internal signaling from AS/NAS to applications, or pre-defined standardized AT-command(s).

For example, the interface can be used to provide the information to the upper layers including one or more parameters related to satellite assistance information for the serving cell such as broadcast in SysteminformationBlockType31 (−NB).

For example, the interface can be used to provide the information to the upper layers including one or more parameters related to satellite assistance information for prediction of discontinuous coverage such as broadcast in SysteminformationBlockType32 (−NB).

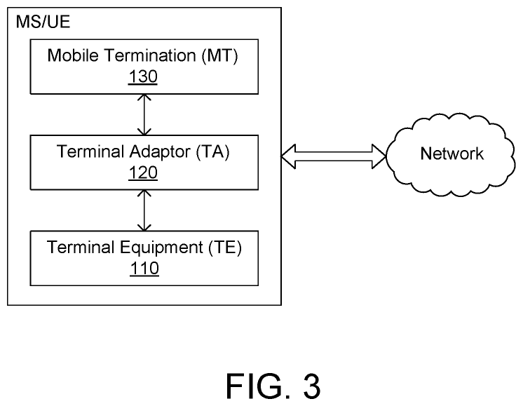

Please refer to FIG. 3, which shows an apparatus implementing the technology described in the present disclosure. The present disclosure also provides an apparatus (e.g., device having appropriate hardware components such as a processing unit, controller, CPU, microprocessor(s), memory or storage, etc. that access and execute corresponding software code) that is able to implement and carry out the above-described method.

The mobile station (MS) comprises all user equipment (UE) and software needed for communication with a mobile network. The mobile station (MS) refers to global system connected to the mobile network, i.e. mobile phone or mobile computer connected using a mobile broadband adapter. This is the terminology of 2G systems like GSM. In the 3G systems, mobile station (MS) is now referred as the user equipment (UE).

In GSM, the mobile station consists of four main components:

Mobile Termination (MT) offers common functions of a such as: radio Transmission and handover, speech encoding and decoding, Error detection and correction, signaling and access to the SIM. The IMEI code is attached to the MT. It is equivalent to the network termination of an ISDN access.

Terminal Equipment (TE) is any device connected to the MS offering services to the user. It does not contain any functions specific to GSM.

Terminal adapter (TA) provides access to the mobile termination (MT) as if it was an ISDN network termination with extended capabilities. Communication between the terminal equipment (TE) and mobile termination (MT) over the terminal adapter (TA) takes place using attention (AT) commands.

Subscriber Identity Module (SIM) is a removable subscriber identification token storing the IMSI a unique key shared with the mobile network operator and other data.

In a mobile phone, the mobile termination (MT), the terminal adapter (TA) and the terminal equipment (TE) are enclosed in the same case. However, the mobile termination (MT) and the terminal equipment (TE) functions are often performed by distinct processors. The application processor serves as a terminal equipment (TE), while the baseband processor serves as a mobile termination (MT), communication between both takes place over a bus using attention (AT) commands, which serves as a terminal adapter (TA).

The various embodiments described herein provide an apparatus comprising: a Mobile Termination (MT) that offers functions related to communication with a network; a Terminal Equipment (TE) that offers services to a user of the apparatus; and a Terminal Adaptor (TA) that allows communication between the MT and the TE using Attention (AT) commands, wherein a discontinuous satellite coverage reporting command (+CDISCO) is one type of attention (AT) command that enables or disables sending of result codes from the mobile termination (MT) to the terminal equipment (TE) in case of the discontinuous satellite coverage.

According to the disclosure as above, the new attention (AT) command +CDISCO for the “Discontinuous coverage” is introduced. Before this attention (AT) command is introduced in this disclosure, there is no way to inform the application layer or the terminal when the user equipment (UE) is in out of service due to the discontinuous coverage or the user equipment (UE) came out from out of service due to discontinuous coverage. There may be also other information to unavailability period and discontinuous coverage that could be useful for application layer/terminal, therefore source-company is considering a dedicated new command would be justified for this purpose. Without proper set of information the application layer/terminal cannot determine whether MO data or MO signaling over NTN can be initiated or not. Therefore, the new attention (AT) command +CDISCO for the “Discontinuous coverage” is introduced in this disclosure.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A user equipment (UE), comprising:
a terminal equipment (TE), for providing services to a user of the user equipment (UE); and
a mobile termination (MT);
wherein the mobile termination (MT) is configured to send to the terminal equipment (TE) an information for indicating a discontinuous satellite coverage.

2. The user equipment (UE) according to claim 1, wherein the information is sent from the mobile termination (MT) to the terminal equipment (TE) using an attention (AT) command.

3. The user equipment (UE) according to claim 2, wherein the attention (AT) command includes a set command including <n>, and <n> is for controlling a presentation of one or more unsolicited result codes of the AT command.

4. The user equipment (UE) according to claim 3, wherein the attention (AT) command includes a read command for returning <n> and <indicator>, and <indicator> is for indicating current discontinuous coverage status for the terminal equipment (TE) or the user equipment (UE).

5. The user equipment (UE) according to claim 3, wherein in <n>, “0” is used to disable presentation of the one or more unsolicited result codes of the AT command.

6. The user equipment (UE) according to claim 3, wherein in <n>, “1” is used to enable presentation of the one or more unsolicited result codes of the AT command.

7. The user equipment (UE) according to claim 3, wherein in <indicator>, “0” is used to indicate that the user equipment (UE) is in a satellite coverage.

8. The user equipment (UE) according to claim 3, wherein in <indicator>, “1” is used to indicate that the user equipment (UE) is currently out of satellite coverage or in the discontinuous satellite coverage.

9. The user equipment (UE) according to claim 3, wherein the attention (AT) command includes a read command for returning at least one <n>, <indicator> for indicating current discontinuous coverage status for the user equipment (UE).

10. The user equipment (UE) according to claim 9, wherein the attention (AT) command is Discontinuous Coverage +CDISCO.

11. The user equipment (UE) according to claim 10, wherein the AT command is specified in 3rd Generation Partnership Project (3GPP) Technical Specification (TS) 27.007.

12. A method for operating a user equipment (UE), wherein the user equipment (UE) includes a terminal equipment (TE), for providing services to a user of the user equipment (UE) and a mobile termination (MT), and the method comprises:
sending to the terminal equipment (TE) an information for indicating a discontinuous satellite coverage.

13. The method according to claim 12, wherein the information is sent from the mobile termination (MT) to the terminal equipment (TE) using an attention (AT) command.

14. The method according to claim 13, wherein the attention (AT) command includes a set command including <n>, and <n> is for controlling a presentation of one or more unsolicited result codes of the AT command.

15. The method according to claim 14, wherein the attention (AT) command includes a read command for returning <n> and <indicator>, and <indicator> is for indicating current discontinuous coverage status for the terminal equipment (TE) or the user equipment (UE).

16. The method according to claim 14, wherein in <n>, “0” is used to disable presentation of the one or more unsolicited result codes of the AT command.

17. The method according to claim 14, wherein in <n>, “1” is used to enable presentation of the one or more unsolicited result codes of the AT command.

18. The method according to claim 14, wherein in <indicator>, “0” is used to indicate that the user equipment (UE) is in a satellite coverage.

19. The method according to claim 14, wherein in <indicator>, “1” is used to indicate that the user equipment (UE) is currently out of satellite coverage or in the discontinuous satellite coverage.

20. The method according to claim 14, wherein the attention (AT) command includes a read command for returning at least one <n>, <indicator> for indicating current discontinuous coverage status for the user equipment (UE).
